(19) United States
(12) Patent Application Publication
(10) Pub. No.: US 2002/0094906 A1
(43) Pub. Date: Jul. 18, 2002

(54) Automatic bicycle shifting system

(76) Inventor: Brian T. Jordan, Chicago, IL (US)

Correspondence Address: SRAM CORPORATION, 1333 N. KINGSBURY, 4TH FLOOR, CHICAGO, IL, 60622, US

(21) Appl. No.: 09/681,116

(22) Filed: Jan. 12, 2001

(51) Int. Cl. B62M 25/08

(52) U.S. Cl. 475/254

(57) ABSTRACT

An automatic bicycle shifting system for automatically controlling the shifting of a bicycle transmission based upon a plurality of wheel speeds selected by rider. The system includes a controller that operates a shifting mechanism such as an internal gear hub system. The system operates in three modes: a setting mode, an automatic mode, and a manual mode. The rider selects the plurality of wheel speeds by manually shifting the bicycle at desired bicycle speeds during the setting mode. The controller stores a bicycle speed each time the rider manually shifts the bicycle during the setting mode in its memory. The stored bicycle speeds are then used by the controller to shift the bicycle during the automatic mode.

### BACKGROUND OF THE INVENTION

This invention relates to bicycle shifting systems and more particularly to an automatic electronic shifting system that allows the rider to choose the bicycle speeds at which automatic shifting of the bicycle transmission will occur.

It is known in the art relating to bicycles to provide an electronic shifting system to shift a transmission of the bicycle. The system may include a controller such as a microprocessor or microcontroller that controls an actuator such as an electric motor or solenoid that actuates a shifting mechanism. The shifting mechanism may be a derailleur or an internal gear hub system. The system may be manually operated such that the rider shifts the bicycle transmission by activating a lever or button that is coupled with the controller or computer. Or the system may be operated automatically based upon certain parameters such as wheel speed or cadence.

For example, the system may be operated automatically in response to the sensed speed of the bicycle. To determine whether the bicycle transmission should be shifted, the controller compares the sensed speed of the bicycle with a speed range stored in the controller's memory for a current gear position of the bicycle. If the sensed speed falls outside of the speed range for the current gear position, the controller activates the actuator which changes the gear position to correspond with the sensed speed. A drawback associated with this configuration is that the shifting occurs at predetermined bicycle speeds which may be different from the desired shifting speeds of the rider. Therefore, a need exists for an automatic shifting system that allows the rider to select the bicycle speeds at which automatic shifting will occur.

### SUMMARY OF THE INVENTION

The present invention provides an automatic shifting system for a bicycle that includes a shift actuator which allows the rider to select the speeds at which shifting of the bicycle transmission will occur. The shift actuator controls a shifting mechanism such as an internal gear hub system or a derailleur that drives a drive wheel of the bicycle at different gear ratios. The system operates in three different modes: a setting mode, an automatic mode, and a manual mode.

The shift actuator includes a housing adaptable to be mounted on the bicycle that encloses a controller. A wheel speed input, a gear control output, a mode selector and a shift point selector are all coupled to the controller to be used by the controller in controlling the shifting of the bicycle transmission. The wheel speed input receives a wheel speed signal that is representative of the bicycle wheel speed. The gear control output transmits a control signal to a gear shifter of the bicycle. The mode selector is actuable by the rider to select between at least the setting mode and the automatic mode. The shift point selector is actuable by the rider to select, while the actuator is in the setting mode, at least one shift point which relates a current wheel speed to a current bicycle gear. A memory is provided for storing at least one shift point which relates at least one stored wheel speed to a respective stored gear. The controller causes at least one shift point to be stored in the memory when the shift actuator is in the setting mode and the rider actuates the shift point selector. The controller, while in the automatic mode, controls the gear shifter through the gear control output such that when the wheel speed signal approximately equals the stored wheel speed, the gear shifter shifts the bicycle into the stored gear.

The shift actuator may also include a display coupled to the controller for displaying various bicycle parameters such as the current gear and current speed of the bicycle. In one embodiment of the present invention, the memory stores a plurality of stored shift points each for a different gear. In another embodiment of the present invention, the memory stores a range of speeds, the range being related to the stored gear. The controller, while in the automatic mode, causes the gear shifter to shift the bicycle into a gear matching the stored gear when the current speed falls into the stored range of speeds.

In still another embodiment of the present invention, the memory stores a plurality of stored gears, a respective plurality of upshifting speeds each corresponding to a respective one of the stored gears and a respective plurality of downshifting speeds each corresponding to a respective one of the stored gears. The controller, when in automatic mode and when the speed of the bicycle is increasing, controls the gear shifter to upshift from a current gear to one of the stored gears when the current speed is greater than a stored upshifting speed corresponding to the one of the stored gears. The controller, when in automatic mode and when the bicycle is decreasing, controls the gear shifter to downshift from a current gear to one of the stored gears when the current speed is less than a stored downshifting speed corresponding to the one of the stored gears.

In another embodiment of the present invention, the shift actuator is further rider-selectable to enter into a manual mode whereby the rider controls the gear shifter.

The present invention also provides a method of controlling the bicycle transmission based on rider-selected wheel speeds. The method includes the steps of actuating a controller mounted on the bicycle to enter a setting mode. Next, the rider manually shifts the bicycle transmission into a selected gear during the setting mode by operating a shift actuator mounted on the bicycle. A bicycle speed is stored for the selected gear in a memory of the controller. The steps of shifting and storing are repeated for each rider-selected gear. Lastly, the controller in accordance with the stored bicycle speeds automatically shifts the bicycle transmission during an automatic mode.

The method may further include the step of defining a plurality of speed ranges based on the stored bicycle speeds such that each speed range corresponds to a gear of the bicycle and the step of shifting the bicycle transmission into a lowest gear after actuating the controller to enter the setting mode. The step of automatically shifting the bicycle may include the steps of measuring a current bicycle speed during the automatic mode; determining a current bicycle speed during the automatic mode; comparing the current bicycle speed with the speed range corresponding to the current gear during the automatic mode; and changing the current gear when the current bicycle speed is outside of the speed range for the current gear during the automatic mode.

These and other features and advantages of the invention will be more fully understood from the following description of certain specific embodiments of the invention taken together with the accompanying drawings.

### BRIEF DESCRIPTION OF DRAWINGS

In the drawings:

FIG. 1 is an elevational view of a multiple gear bicycle incorporating the present invention;

FIG. 2 is a block diagram of the automatic shifting system in accordance with the present invention;

FIG. 3 is a rear end view of an internal gear hub system and a gear shifter coupled to a rear wheel of the bicycle of FIG. 1 in accordance with the present invention;

FIG. 4 is an axial sectional view of an internal gear hub system;

FIG. 5 is a front view of a shift actuator;

FIG. 6 is a plan view of a portion of the handlebars of the bicycle;

FIG. 7 is a plan view of an electronic twist shifter;

FIG. 8 is a bottom isometric view of the gear shifter of FIG. 3;

FIG. 9 is a top isometric view of a position sensor, a position lever, and a position switch of the gear shifter of FIG. 3;

FIG. 10 is a top isometric view of a motor and gear reducer of the gear shifter of FIG. 3;

FIGS. 11-13 are flow charts of the operation of the automatic shifting system in accordance with the present invention; and

FIG. 14 is a graph of gear position vs. bicycle speed illustrating the shifting of the automatic bicycle shifting system.

### DETAILED DESCRIPTION

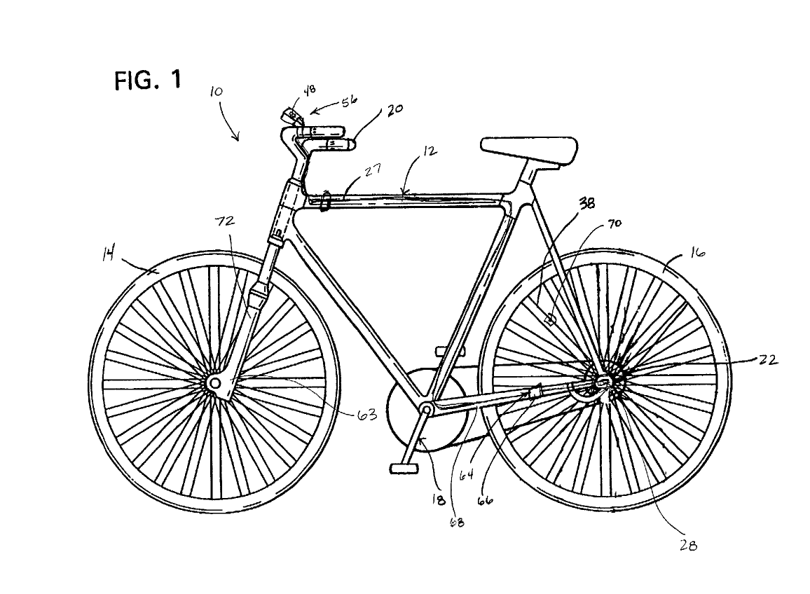

Referring to FIG. 1 of the drawings in detail, numeral 10 generally indicates a bicycle incorporating the present invention. The bicycle 10 includes a frame 12; a front wheel 14; a rear wheel 16; a drive component 18 such as a crank, chain ring (s) and drive chain; and handlebars 20. The frame 12 supports an automatic shifting system that may automatically shifts the bicycle transmission according to bicycle speeds selected by the rider. While the illustrated bicycle 10 is a mountain bike, the present invention has applications to bicycles of any type, including road bikes and others.

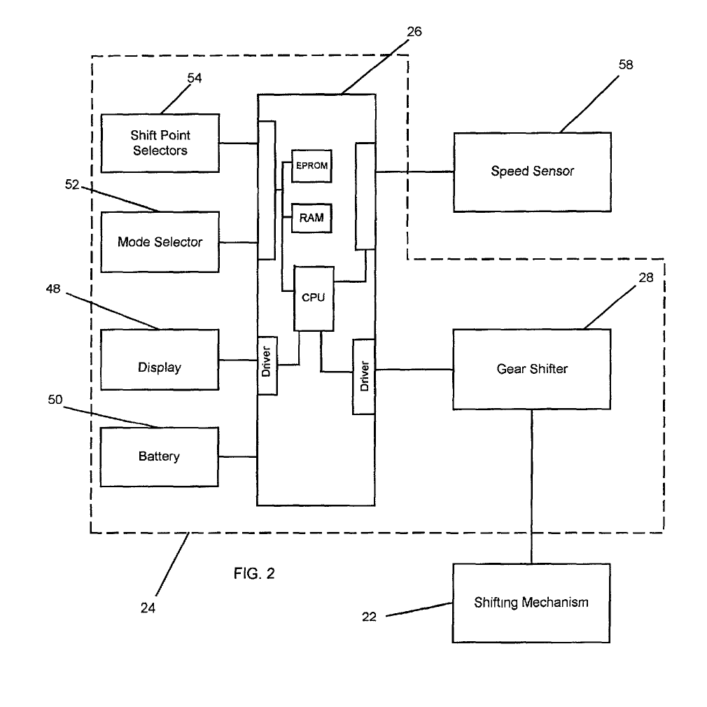

Referring to FIG. 2, the shifting system generally includes a shifting mechanism 22 and a shift actuator 24. The shift actuator 24 includes a controller 26 that controls a gear shifter 28 which changes the gear position of the shifting mechanism 22 upon receiving a control signal from the controller 26 via a wire 27 extending along the frame 12 between the controller 26 and the gear shifter 28.

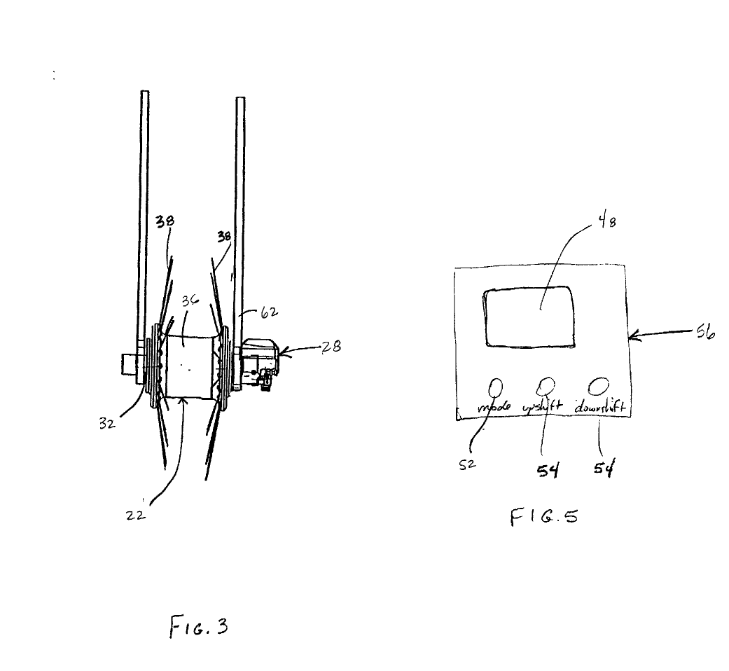

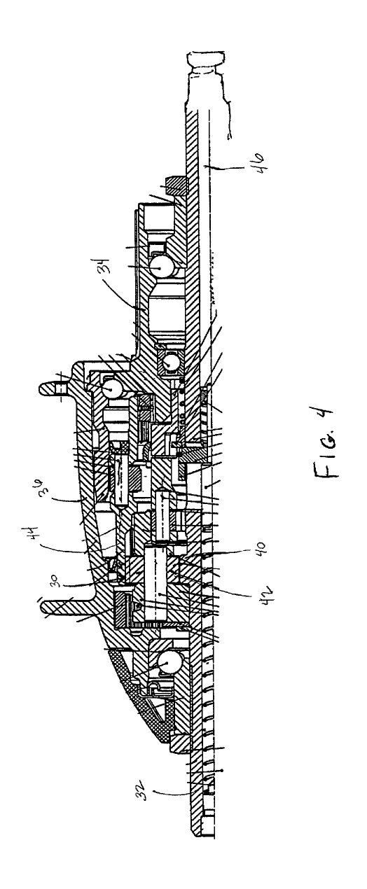

In one embodiment of the present invention, the shifting mechanism 22 is a 3-speed internal gear hub system located in the rear wheel hub as shown in FIG. 3. Alternatively, the shifting mechanism may be a derailleur. Referring to FIG. 4, the internal gear hub system 22 makes use of a planetary gear mechanism 30 to provide a plurality of gears or transmission modes. The basic structure of the internal hub 22 includes a hub shaft 32 that is rotationally fixed to the bicycle 10, a driver 34 that is rotatably supported on this hub shaft 32 by bearings or the like and that transmits the drive force from the a bicycle chain via a gear (not shown), and a hub shell 36 that transmits the drive force from the driver via a plurality of drive force transmission routes. The rear wheel 16 is supported on the hub shell 36 via spokes 38 (FIG. 3).

The planetary gear mechanism 30 that forms the plurality of drive force transmission routes generally includes a sun gear 40 disposed about the hub shaft 32 and planet gears 42 that engage the sun gear 40. A ring gear 44 is provided radially outward from the planet gear 42 to engage the teeth of the planet gear 42. The transmission path through the planetary gear mechanism 30 is selected by a shift pin 46 disposed within the hub shaft 32. While a representative internal hub 22 has been shown, this internal hub 22 can be any of various conventional types known to one skilled in the art.

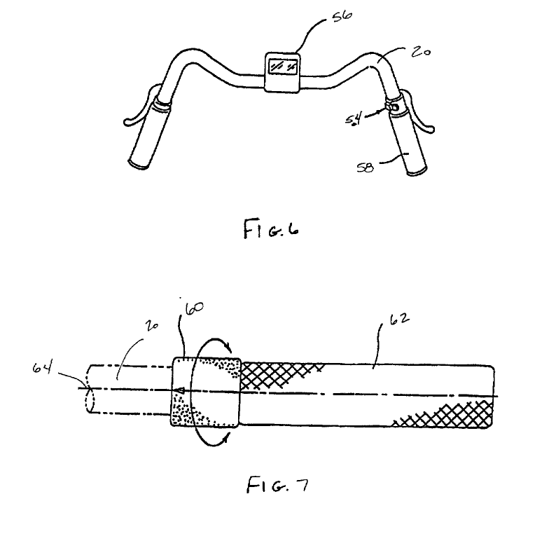

Referring to FIG. 2, the shift actuator 24 generally includes the controller 26, the gear shifter 28, a display device 48, a battery 50, a mode selector or switch 52, and shift point selectors or switches 54. The controller 26 may be a microprocessor or microcontroller consisting of a central processing unit (CPU), a random access memory (RAM), a read only memory (ROM), and an input/output (I/O) interface. A housing 56 encloses the controller that is coupled to the battery or power supply 50 and the display device 48(see FIGS. 1 and 5). The housing 56 is mounted on the handlebars 20 for easy access by the rider.

Controller 26 is preferably a large-scale integrated circuit microcontroller having an integrated CPU, an electrically programmable read-only memory (EPROM) into which is programmed the shifter control, display and wheel speed calculation algorithms described herein as well as default shift points, a random access memory (RAM), one or more control outputs including at least one connected to gear shifter 28 and a display driver suitable for driving the display 48. Preferably, the controller 26 has a reduced instruction set (RISC) CPU and has CMOS RAM to reduce power requirements. In one commercial embodiment the controller 26 can consist of a Microchip PIC 16C923 microcontroller. The RAM of the controller 26 stores the rider-entered shift points (relating wheel speed to gear and discussed in detail below) and uses power from the battery 50 to retain these shift points in memory.

In alternative embodiments the rider-entered shift points may be stored in a memory device. While the controller 26 is preferably a single integrated circuit, its functions can be implemented in multiple circuits or devices. Further, while in the illustrated embodiment the microcontroller has a multi-purpose, programmable CPU which executes instructions of a computer program loaded into its EPROM, the controller could also be a more application-specific integrated circuit (ASIC) whose functions and logic, completely or to a large extent, are hardwired.

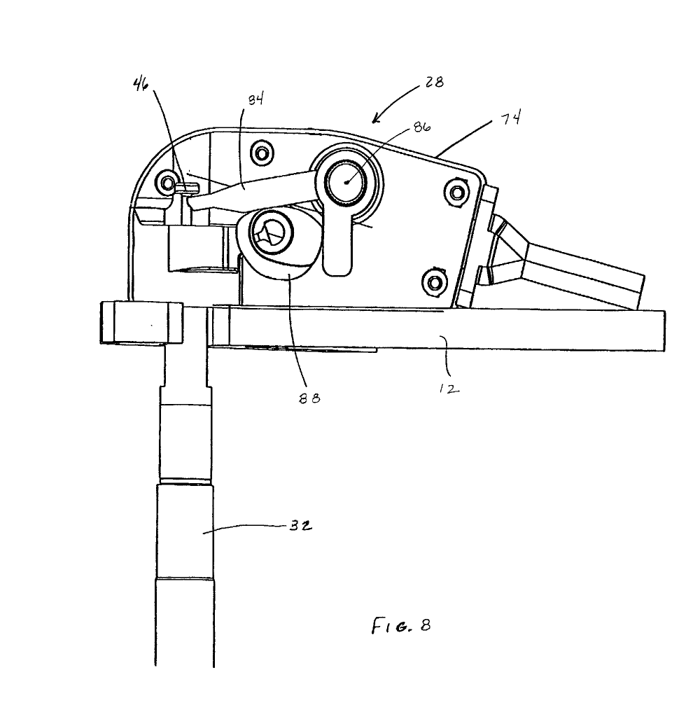

The system operates in three different modes of operation: a setting mode, an automatic mode, and a manual mode. The rider selects the mode of operation by pressing the mode selector 52 coupled to the controller and mounted on an outer surface of the housing 56 (see FIG. 5). The controller 26 shifts the shifting mechanism 22 based upon stored bicycle speeds during the automatic mode or when the rider manually presses the shift point switches 54 during the manual mode. The switches 54 are disposed in the outer surface of the housing as shown in FIG. 5. One of the shift point switches 54 is used for performing upshifts to a higher gear from a lower gear, while the other switch is used for performing downshifts to a lower gear from a higher gear. Alternatively, only one switch may be provided to perform the mode and shift operations. For example, to enter the mode operation the switch may be held down for a certain period of time and subsequent presses would shift the bicycle. In another embodiment, the shift point switches 54 may be mounted adjacent a grip 58 disposed on an end of the handlebars 20 as shown in FIG. 6. The shift point switches 54 are coupled to the controller 26 via a wire (not shown) extending through the handlebar 20.

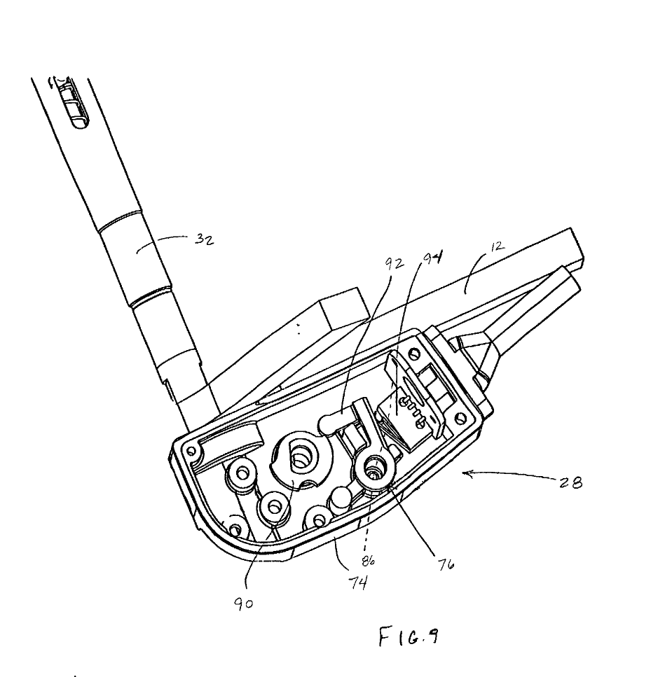

Referring to FIG. 7, the manual shifting may be accomplished by the rider operating an electronic twist shifter 60 mounted on an end of the handlebar 20 inboard a stationary grip 62 and coupled to the controller 26 via a wire extending through the handlebar 20. The rider rotates the shifter 60 about an axis 63 of the handlebar 20 to actuate a shift. The shifter 60 includes a spring (not shown) biasing it in a starting position or home position. The shifter 60 is rotated in one direction from the starting position to shift up and rotated in the other direction to shift down. Additionally, various combinations of holding and rotating the shifter 60 in certain directions may be used to select to the mode of operation or to determine what information is displayed on the display device 48. This configuration allows the rider to operate the shifting system without removing his hand from the handlebar.

During all three modes of operation, the controller 26 determines the speed of the bicycle and displays the speed on the display device 48. The controller 26 determines the speed of the bicycle from a wheel speed input that receives a wheel speed signal from a wheel speed sensor 64 mounted on the bicycle 10. Referring to FIG. 1, the speed sensor 64 includes a reed switch 66 mounted on a chain stay 68 of the bicycle frame 12 and a magnet 70 attached to one of the rear wheel spokes 38. The speed sensor 64 generates the speed signal responsive to the passage of the magnet 70 across the switch 66, or each revolution of the rear wheel 16. The system may allow the rider to input a wheel size to be used to calculate the wheel speed otherwise a default value stored in the EPROM is used. Alternatively, the reed switch 66 may be mounted on a fork 72 and the magnet 70 may be attached to one of the front wheel spokes.

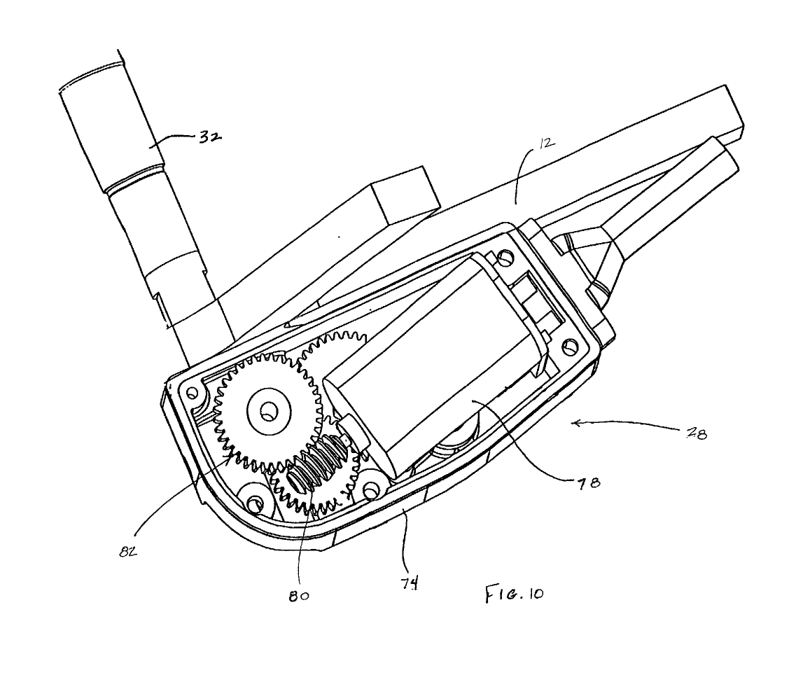

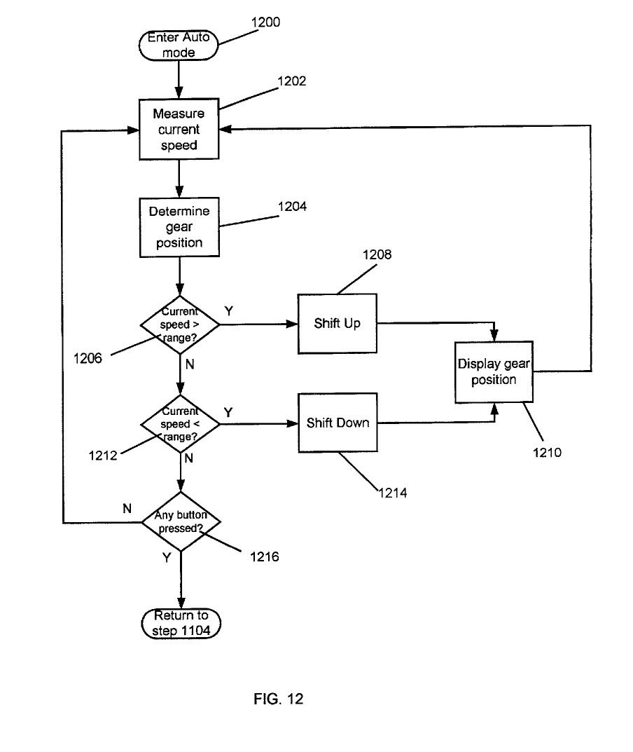

The gear shifter 28 changes the gear position of the shifting mechanism 22 upon receiving a control signal from a gear control output coupled to the controller 26. The gear shifter 28 is mounted on the hub shaft 32. Referring to FIGS. 8-10, the gear shifter 28 generally includes a housing 74 enclosing a position sensor 76, a DC motor 78 having an output shaft which terminates in a worm gear 80, a gear reducer 82, a lever 84 pivoting about an axis 86 and a gear-indexing cam 88. Upon the actuator 28 receiving the shift signal, the motor 78 produces a high speed, low torque motion on gear 80 that is converted to a high torque, low speed motion by the gear reducer 82 which in turn consists of a plurality of interconnecting gears. The gear reducer 82 rotates the gear-indexing cam 88 to which gear reducer 82 is axially affixed, the cam 88 rotating the lever 84 around axis 86. The lever 84 drives the shift pin 46 of the internal hub 22 in or out of the hub shaft 32 into different positions depending on the desired gear position and the current gear position.

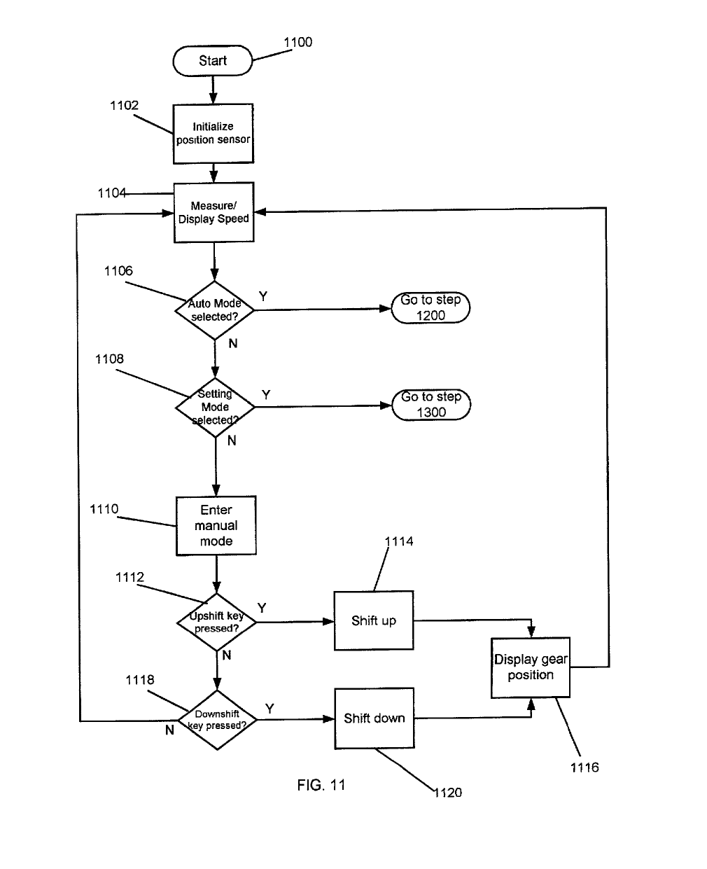

The current gear position is determined by the controller 26 from the position sensor 76 (FIG. 9). The position sensor 76 includes a position cam 90, a position lever 92 and a microswitch 94. Three positions on the cam 90 correspond to three gear positions of the internal hub 22. The gear-indexing cam 88 rotates the position cam 90. As the position cam 90 rotates, the position lever 92 is moved. The microswitch 94 is activated every time the lever 92 moves. The microswitch 94 generates a gear position signal indicative of the current gear of the internal hub 22 that is received by the controller 26 to be used in shifting the internal hub.

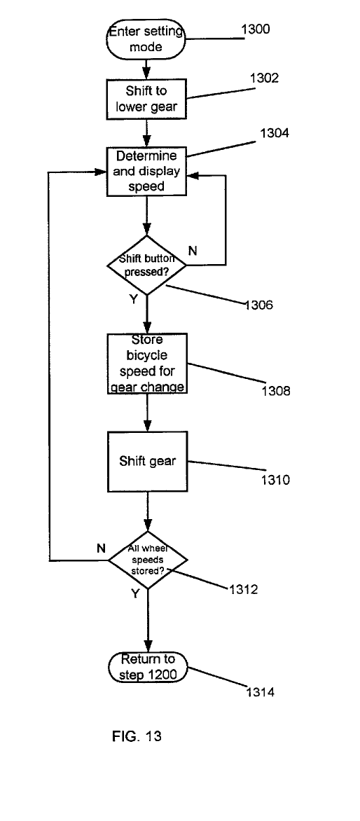

Generally, the shifting mechanism 22 is shifted by the controller 26 based on wheel speeds stored in its memory or when the rider presses the upshift or downshift buttons. The controller carries out a series of operations stored in an instruction-by-instruction format in EPROM to control the shifting mechanism. More specifically, such an operation is initiated at step 1100 of FIG. 11 upon the rider riding the bicycle. First, the controller initializes the position sensor into a home position or the lowest gear at a step 1102 and displays that gear. Next, the controller determines the bicycle speed from the wheel speed signal received from the wheel sensor and displays the bicycle speed at a step 1104.

As stated above, the system operates in three different modes of operation: manual, automatic and setting modes. The controller checks whether the automatic mode has been selected at a step 1106. If the automatic mode has been selected, the operation enters the automatic mode at a step 1200 of FIG. 12. If the automatic mode has not been selected, the controller checks whether the setting mode as been selected at a step 1108. If the setting mode has been selected, the operation enters the setting mode at a step 1300. If neither of these modes of operation have been selected, the operation enters the manual mode at a step 1110. Next, the controller checks whether the upshift switch has been pressed at a step 1112. If the upshift switch has been pressed, the controller sends a control signal to the gear shifter and the internal hub is shifted to the next highest gear at a step 1114 and the new gear is displayed at a step 1116. After displaying the gear, the operation returns to step 1104. If the upshift switch has not been pressed, the controller checks whether the downshift switch has been pressed at a step 1118. If the downshift switch has been pressed, the controller sends a control signal to the gear shifter and the internal hub is shifted down to the next lowest gear at a step 1120 and the new gear position is displayed at the step 1116. After displaying the gear, the operation returns to step 1104. If the downshift switch has not been pressed the operation returns to the step 1104.

Returning to step 1106 (FIG. 11), when the automatic mode is selected, the controller shifts the bicycle transmission based upon wheel speeds stored in its memory. The stored wheel speeds may be wheel speeds selected by the rider and stored in the RAM or may be the default wheel speeds stored in the EPROM. The stored speeds define the limits of a plurality of speed ranges. Each speed range corresponds to a gear of the bicycle transmission. Referring to FIG. 12, the automatic mode is entered at a step 1200. First, the controller determines the current bicycle speed at a step 1202. Next, the controller determines what gear the internal hub is in at a step 1204. Then the controller compares the current speed to a speed range for that gear at a step 1206. If the current speed is greater than a maximum speed of the speed range for that gear, the operation proceeds to a step 1208 and the controller will generate a control signal to shift the transmission in an upshift direction. The control signal is sent to the gear shifter instructing it to change the gear of the shifting mechanism. The new gear is displayed at a step 1210.

If the current speed is not greater than the maximum bicycle speed for that speed range then the operation proceeds to the next step. At a step 1212, the controller determines whether current speed is less than a minimum bicycle speed for the speed range for the current gear. If the current speed is less than the minimum bicycle speed for that gear, the operation proceeds to a step 1214 and the controller will generate a control signal to shift the transmission in a downshift direction. The control signal is sent to the gear shifter 28 which in response to signal changes the gear of the shifting mechanism. The new gear is displayed at the step 1210. The controller continues to compare the current speed with the stored speeds for each gear until the riders chooses to exit the automatic mode by pressing the mode selector, upshift switch or downshift switch at a step 1216.

Returning to step 1108 (FIG. 11), if the rider has selected the setting mode, the operation proceeds to a step 1300 in FIG. 13. After the setting mode of operation is entered, the controller shifts the shifting mechanism to the lowest gear at a step 1302. The controller determines and displays the current bicycle speed at a step 1304. Next, when the rider has presses the upshift switch, an upshift signal is sent to the controller at a step 1306. The controller stores the bicycle speed at which the rider pressed the upshift switch in RAM such that it represents approximately the maximum wheel speed for the current gear and approximately the minimum wheel speed for the next gear at a step 1308. The controller shifts the shifting mechanism to the next highest gear at a step 1310. After it has been determined that all the wheel speed ranges have been stored in RAM for each gear position at a step 1312, the controller exits the setting mode operation at a step 1314 and enters the automatic mode. The system may also provide a time out feature requiring the rider to input the wheel speeds within a certain period of time. For example, if the rider does not set all the wheel speeds within 30 seconds, the system exits the setting mode without saving any of the wheel speeds and returns to the automatic mode.

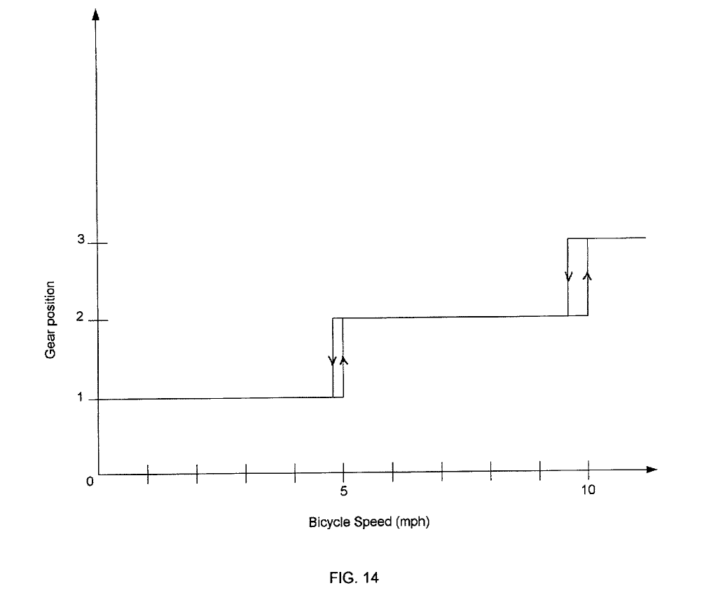

In one embodiment of the present invention, the operation only stores a bicycle speed when the rider changes gears either in an upshift direction or a downshift direction. The controller calculates a plurality of bicycle speeds for changing gears for the nonselected upshift or downshift direction in accordance with the stored bicycle speeds for changing gears in the selected upshift or downshift direction. For example if the rider selects only the speeds for changing gears in the upshift direction, the upshift speeds are multiplied by a hysteresis parameter to make the downshift speeds to be slightly lower than the corresponding upshift speeds as shown in FIG.14. The downshift speeds in FIG. 14 were determined by multiplying the upshift speeds by a hysteresis parameter of 0.96. For example, if the rider shifts from gear one to gear two at 5 mph, the downshift speed from gear two to gear one equals 5×0.96 or 4.8 mph. This allows the rider to have to only enter the upshift speeds.

Alternatively, the rider may enter the downshift speeds by manually shifting the shifting mechanism during deceleration of the bicycle. For example, the rider would accelerate and shift the bicycle transmission at desired upshift speeds and then would begin to decelerate after entering all the upshift speeds. While decelerating, the rider would shift at desired downshift speeds and the controller would store each downshift speed. The upshift speeds and downshift speeds are stored in memory and make up speed ranges that the controller uses to shift the bicycle transmission during the automatic mode.

In another embodiment of the present invention, the stored shift points may be set within a range of the bicycle speed at which the rider shifted the transmission during the setting mode. For example, if the rider shifts the bicycle from first gear to second gear at 10 mph, the system while in the automatic mode will shift the transmission from first to second gear or in an upshift direction at 10.5 mph. And when the system shifts from second back to first gear or in a downshift direction, the system shifts the transmission at 9.5 mph.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

1. A method for controlling a bicycle transmission based on rider-selected wheel speeds, the method comprising the steps of:
actuating a controller mounted on a bicycle to enter a setting mode;
manually shifting the bicycle transmission into a selected gear during the setting mode by operating a shift actuator coupled to the bicycle transmission;
storing a bicycle speed for the selected gear in a memory of the controller;
repeating said steps of shifting and storing for each rider-selected gear; and
automatically shifting the bicycle transmission by the controller in accordance with the stored bicycle speeds during an automatic mode.

2. A method as in claim 1 further including the step of defining a plurality of speed ranges in accordance with the stored bicycle speeds such that each speed range corresponds to a gear of the bicycle transmission.

3. A method as in claim 2 wherein the step of automatically shifting the bicycle transmission includes the steps of:
measuring a current bicycle speed during the automatic mode;
determining a current gear during the automatic mode;
comparing the current bicycle speed with the speed range corresponding to the current gear during the automatic mode; and
changing the current gear when the current bicycle speed is outside of the speed range for the current gear during the automatic mode.

4. A method as in claim 3 wherein the step of changing the current gear includes the steps of:
changing the current gear to a higher gear when the current bicycle gear is greater than the speed range corresponding to the current gear; and
changing the current gear to a lower gear when the current bicycle speed is less than the speed range corresponding to the current gear.

5. A method as in claim 1 further comprising the step of shifting the bicycle transmission into a lowest gear after actuating the controller to enter the setting mode.

6. A method as in claim 1 wherein the step of storing a bicycle speed includes the steps of:
storing a bicycle speed only when the rider changes gears from a selected one of an upshift direction and a downshift direction; and
calculating a plurality of bicycle speeds for changing gears for the nonselected one of the upshift direction and the downshift direction in accordance with the stored bicycle speeds for changing gears in the selected one of the upshift direction and the downshift direction.

7. A method as in claim 1 wherein the step of storing a bicycle speed includes the step of calculating a plurality of bicycle speeds for automatically changing gears in one of an upshift direction and a downshift direction in accordance with the stored bicycle speed for the selected gear.

8. A method as in claim 1 wherein each stored bicycle speed is equal to a bicycle speed greater than the preceding stored bicycle speed.

9. A method as in claim 1 wherein the step of actuating the controller to enter the setting mode includes the step of actuating a mode switch coupled to the controller to enter the setting mode.

10. A method as in claim 1 wherein the step of shifting the bicycle transmission in a selected gear includes the step of further comprising the step of actuating a shift control switch coupled to the controller to shift the bicycle transmission.

11. A method for selecting a plurality of bicycle speeds to be used to automatically control the shifting of a bicycle transmission, the method comprising the steps of:
actuating a controller mounted on a bicycle to enter a setting mode;
manually shifting the bicycle transmission into a selected gear during the setting mode by operating a shift actuator coupled to the bicycle transmission;
storing a bicycle speed for the selected gear in a memory of the controller; and
repeating said steps of shifting and storing for each rider-selected gear.

12. A method as in claim 11 further comprising the step of shifting the bicycle transmission to a lowest gear after actuating the controller to enter the setting mode.

13. A method as in claim 11 wherein the step of storing a bicycle speed comprises the steps of:
storing a bicycle speed only when the rider changes gears from a selected one of an upshift direction and a downshift direction; and
calculating a plurality of bicycle speeds for changing gears for the nonselected one of the upshift direction and the downshift direction in accordance with the stored bicycle speeds for changing gears in the selected one of the upshift direction and the downshift direction.

14. A method as in claim 11 wherein the step of storing a bicycle speed includes the step of calculating a plurality of bicycle speeds for automatically changing gears in one of an upshift direction and a downshift direction in accordance with the stored bicycle speed for the selected gear.

15. A method as in claim 11 wherein the step of actuating the controller to enter the setting mode includes the step of actuating a mode switch coupled to the controller to enter the setting mode.

16. A method as in claim 11 wherein the step of manually shifting the bicycle transmission includes the step of actuating a shift control switch coupled to the controller to shift the bicycle transmission.

17. A shift actuator for a multiple-gear bicycle comprising:
a housing adaptable to be mounted on the bicycle;
a wheel speed input for receiving a wheel speed signal that is representative of the bicycle wheel speed;
a gear control output for transmitting a control signal to a gear shifter of the bicycle;
a mode selector actuable by a rider to select between at least a setting mode and an automatic mode;
a shift point selector actuable by the rider to select, while the shift actuator is in the setting mode, at least one shift point which relates a current wheel speed to a current bicycle gear;
a memory for storing at least one shift point which relates at least one stored wheel speed to a respective stored gear; and
a controller coupled to the wheel speed input, the gear control output and the mode selector, the controller causing said at least one shift point to be stored in the memory when the shift actuator is in the setting mode and the rider actuates the shift point selector, the controller, while in the automatic mode, controlling the gear shifter through the gear control output such that when the wheel speed signal approximately equals the stored wheel speed, the gear shifter shifts the bicycle into the stored gear.

18. The shift actuator of claim 17, and further comprising a display coupled to the controller for displaying the current gear of the bicycle.

19. The shift actuator of claim 18, wherein the display further displays a current speed of the bicycle.

20. The shift actuator of claim 17, wherein the memory stores a plurality of stored shift points each for a different gear.

21. The shift actuator of claim 17, wherein the memory stores a range of speeds, the range being related to the stored gear, the controller, while in the automatic mode, causing the gear shifter to shift the bicycle into a gear matching the stored gear when the current speed falls into the stored range of speeds.

22. The shift actuator of claim 17, wherein the memory stores a plurality of stored gears, a respective plurality of upshifting speeds each corresponding to a respective one of the stored gears and a respective plurality of downshifting speeds each corresponding to a respective one of the stored gears, the controller, when in automatic mode and when the speed of the bicycle is increasing, controlling the gear shifter to upshift from a current gear to one of the stored gears when the current speed is greater than a stored upshifting speed corresponding to said one of the stored gears, the controller, when in automatic mode and when the speed of the bicycle is decreasing, controlling the gear shifter to downshift from a current gear to one of the stored gears when the current speed is less than a stored downshifting speed corresponding to said one of the stored gears.

23. The shift actuator of claim 17, wherein the shift actuator is further rider-selectable to enter into a manual mode whereby the rider controls the gear shifter.

24. A medium onto which has been prerecorded a computer program which, when executed by a gear shifter controller mounted on a multiple-gear bicycle, is capable of performing the following steps:
actuating a controller mounted on the bicycle to enter a setting mode;
manually shifting the bicycle transmission into a selected gear during the setting mode by operating a shift actuator coupled to the bicycle transmission;
storing a bicycle speed for the selected gear in a memory of the controller;
repeating said steps of shifting and storing for each rider-selected gear; and
automatically shifting the bicycle transmission by the controller in accordance with the stored bicycle speeds during an automatic mode.

25. A medium as in claim 24 further including the step of defining a plurality of speed ranges in accordance with the stored bicycle speeds such that each speed range corresponds to a gear of the bicycle transmission.

26. A medium as in claim 25 wherein the step of automatically shifting the bicycle transmission includes the steps of:
measuring a current bicycle speed during the automatic mode;
determining a current gear during the automatic mode; comparing the current bicycle speed with the speed range corresponding to the current gear during the automatic mode; and
changing the current gear when the current bicycle speed is outside of the speed range for the current gear during the automatic mode.

27. A medium as in claim 24 further comprising the step of shifting the bicycle transmission into a lowest gear after actuating the controller to enter the setting mode.

28. A medium as in claim 24 wherein the step of storing a bicycle speed includes the steps of:
storing a bicycle speed only when the rider changes gears from a selected one of an upshift direction and a downshift direction; and
calculating a plurality of bicycle speeds for changing gears for the nonselected one of the upshift direction and downshift direction in accordance with the stored bicycle speeds for changing gears in the selected one of the upshift direction and the downshift direction.
